(19) United States
(12) Patent Application Publication
(10) Pub. No.: US 2026/0329739 A1
(43) Pub. Date: Oct. 22, 2026

(54) AI Augmented Testing Requirements Derivation

(71) Applicant: NATIONAL INSTRUMENTS CORPORATION, Austin, TX (US)

(72) Inventors: Alejandro Barreto, Austin, TX (US); Max Allen Rector, Lakeland, FL (US)

(21) Appl. No.: 19/468,563

(22) Filed: Feb. 3, 2026

Related U.S. Application Data
(60) Provisional application No. 63/753,313, filed on Feb. 3, 2025.

(51) Int. Cl. G06F 11/3668; G06F 8/10; G06F 9/451

(52) U.S. Cl. CPC G06F 11/3692; G06F 8/10; G06F 9/451

(57) ABSTRACT

Apparatuses, systems, and methods for testing requirements derivation, e.g., using a generative AI based system to derive requirements and tests for a device under test (DUT) from a test program and related materials and generate associated documentation. A large language model (LLM), e.g., AI, can be leveraged to automate requirements extraction, augment derivation of requirements tables (or table), and to collaborate on validation documents generation.

### PRIORITY CLAIM

This application claims benefit of priority to provisional application number 63/753,313 entitled “AI Augmented Testing Requirements Derivation”, filed on Feb. 3, 2025, whose disclosure is hereby incorporated by reference in its entirety as though fully and completely set forth herein.

### TECHNICAL FIELD

The invention relates to testing requirements derivation, and more particularly to apparatuses, systems, and methods for generative Artificial Intelligence (AI) assisted testing requirements derivation, e.g., using a generative AI based system to derive requirements and tests for a device under test (DUT) from a test program and related materials and generate associated documentation.

### DESCRIPTION OF THE RELATED ART

Currently, there are a variety of tools to support a test engineer in test process development when given a specification of a DUT (also referred to as a unit under test (UUT)). For example, there are tools to aid a test engineer in the front-end of life cycle of a test process, e.g., such as tools to match tests to instruments. Further, there are tools to aid a test engineer in the back end of the life cycle of the test process, e.g., such as tools that provide measurement abstraction. In addition, there are various tools that provide high-level test support as well as tools that can generate test sequences based on detailed inputs from the test engineer.

However, a test engineer may need to work/interact with many, disparate software systems to leverage these various tools to develop the test process for the DUT. For example, in various aspects of development of the test process, a test engineer may have the role of a design engineer (e.g., during design of the DUT and/or development of tests that validate the design of the DUT as well as during design of tests than can be reused across the test life cycle of the DUT), test architect (e.g., during design of test systems and identification of reusable components for tests), validation engineer (e.g., during characterization and validation of DUTs), and/or production test engineer (e.g., during development of tests that monitor production processes as well as yield of production DUTs). Each role/tool may require its own expertise and resource, leading to high overhead costs in time, training, and expertise develop. These high overhead costs may then extend time to market for particular products. Accordingly, improvements are desirable.

### SUMMARY

Embodiments described herein relate to computing systems, memory media, and methods for generative Artificial Intelligence (AI) assisted testing requirements derivation, e.g., using a generative AI based system to derive requirements and tests for a device under test (DUT) from a test program and related materials and generate associated documentation.

For example, in some embodiments, an AI (e.g., a large language model (LLM)) can access a test program, e.g., for testing a DUT. The AI can analyze the test program, e.g., review, consume, and/or compare to previously analyzed test programs, a structure of the test program, logic of the test program, and/or outputs of the test program. In addition, the AI can infer and/or derive functional requirements and/or non-functional requirements (e.g., derived requirements) of the DUT, e.g., based on the analysis of the test program.

As another example, in some embodiments, an AI (e.g., a large language model (LLM)) can infer and/or derive functional requirements and/or non-functional requirements (e.g., derived requirements) of a device under test (DUT), e.g., based on an analysis of a test program. In addition, the AI can (automatically) generate a table and/or one or more other user interface elements, e.g., based on the inferred and/or derived functional requirements and/or non-functional requirements (e.g., derived requirements) of the DUT. The table can be a structured, editable table. The table and/or the one or more other user interface elements can include derived requirements. The derived requirements can include links to source evidence (e.g., specifications, logs, video files, and so forth).

As a further example, in some embodiments, an AI (e.g., a large language model (LLM)) can infer and/or derive functional requirements and/or non-functional requirements (e.g., derived requirements) of a device under test (DUT), e.g., based on an analysis of a test program. In addition, the AI can generate a validation document, e.g., based on the derived requirements. Hence, the AI can apply a validation document template and fill in sections of the validation document template using the derived requirements and/or user inputs to generate the validation document.

As a yet further example, in some embodiments, an AI (e.g., a large language model (LLM)) can access a test program, e.g., for testing a DUT. The AI can analyze the test program, e.g., review, consume, and/or compare to previously analyzed test programs, a structure of the test program, logic of the test program, and/or outputs of the test program. In addition, the AI can infer and/or derive functional requirements and/or non-functional requirements (e.g., derived requirements) of the DUT, e.g., based on the analysis of the test program. In addition, the AI can (automatically) generate a table and/or one or more other user interface elements, e.g., based on the inferred and/or derived functional requirements and/or non-functional requirements (e.g., derived requirements) of the DUT. The table can be a structured, editable table. The table and/or the one or more other user interface elements can include derived requirements. The derived requirements can include links to source evidence (e.g., specifications, logs, video files, and so forth). Further, the AI can generate a validation document, e.g., based on the derived requirements. Hence, the AI can apply a validation document template and fill in sections of the validation document template using the derived requirements and/or user inputs to generate the validation document.

Note that the techniques described herein can be implemented in and/or used with a number of different types of devices, including but not limited to cellular phones, tablet computers, wearable computing devices, portable computing devices, portable media players, and any of various other computing devices.

This Summary is intended to provide a brief overview of some of the subject matter described in this document. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the disclosed embodiments can be obtained when the following detailed description of the preferred embodiments is considered in conjunction with the following drawings.

FIG. 1 illustrates an example of a computer system, according to some embodiments.

FIG. 2 illustrates an example block diagram of a server 104, according to some embodiments.

FIG. 3 illustrates an example of a system supporting a test generation system, according to some embodiments.

For example, FIGS. 4, 5, 6, and 7 illustrate block diagrams of examples of methods for testing requirements derivation for a DUT, according to some embodiments.

While the features described herein can be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that can appear throughout the present disclosure are provided below:
AI: Artificial Intelligence
DUT: Device Under Test
UUT: Unit Under Test
VI: Virtual Instrument
GUI: Graphical User Interface
LLM: Large Language Model
JSON: JavaScript Object Notation

### Terms

The following is a glossary of terms used in this disclosure:
Device Under Test (DUT) or Unit Under Test (UUT)—A physical device or component that is being tested.
Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium can include other types of non-transitory memory as well or combinations thereof. In addition, the memory medium can be located in a first computer system in which the programs are executed, or can be located in a second different computer system which connects to the first computer system over a network, such as the Internet. In the latter instance, the second computer system can provide program instructions to the first computer for execution. The term “memory medium” can include two or more memory mediums which can reside in different locations, e.g., in different computer systems that are connected over a network. The memory medium can store program instructions (e.g., embodied as computer programs) that can be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks can range from fine grained (combinatorial logic or look up tables) to coarse grained (arithmetic logic units or processor cores). A programmable hardware element can also be referred to as “reconfigurable logic”.
Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.
Processing Element (or Processor)—refers to various elements or combinations of elements that are capable of performing a function in a device, such as a user equipment or a cellular network device. Processing elements can include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.
Program—the term “program” is intended to have the full breadth of its ordinary meaning. The term “program” includes 1) a software program which can be stored in a memory and is executable by a processor or 2) a hardware configuration program useable for configuring a programmable hardware element.
Software Program—the term “software program” is intended to have the full breadth of its ordinary meaning, and includes any type of program instructions, code, script and/or data, or combinations thereof, that can be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program can comprise two or more software programs that interoperate in some manner.
Hardware Configuration Program—a program, e.g., a netlist or bit file, that can be used to program or configure a programmable hardware element.
Graphical Program—A program comprising a plurality of interconnected nodes or icons, where the plurality of interconnected nodes or icons visually indicate functionality of the program. Can also be referred to as a Virtual Instrument (VI).
Data Flow Graphical Program (or Data Flow Diagram)—A graphical program or diagram comprising a plurality of interconnected nodes, wherein the connections between the nodes indicate that data produced by one node is used by another node. Can also be referred to as a Virtual Instrument (VI).
Graphical User Interface—this term is intended to have the full breadth of its ordinary meaning. The term “graphical user interface” is often abbreviated to “GUI”. A GUI can comprise only one or more input GUI elements, only one or more output GUI elements, or both input and output GUI elements. Can also be referred to as a Virtual Instrument (VI).

The following provides examples of various aspects of GUIs. The following examples and discussion are not intended to limit the ordinary meaning of GUI, but rather provide examples of what the term “graphical user interface” encompasses:

A GUI can comprise a single window, panel, or dialog box having one or more GUI Elements, or can comprise a plurality of individual GUI Elements (or individual windows each having one or more GUI Elements), wherein the individual GUI Elements or windows can optionally be tiled together.
Graphical User Interface Element—an element of a graphical user interface, such as for providing input or displaying output. Exemplary graphical user interface elements include input controls and output indicators.
Input Control—a graphical user interface element for providing user input to a program. Exemplary input controls include buttons, check boxes, input text boxes, knobs, sliders, etc.
Output Indicator—a graphical user interface element for displaying output from a program. Exemplary output indicators include charts, graphs, gauges, output text boxes, numeric displays, etc. An output indicator is sometimes referred to as an “output control”.
Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure can be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form can be automatically filled out by the computer system where the computer system (e.g., software executing on the computer system) analyzes the fields of the form and fills in the form without any user input specifying the answers to the fields. As indicated above, the user can invoke the automatic filling of the form, but is not involved in the actual filling of the form (e.g., the user is not manually specifying answers to fields but rather they are being automatically completed). The present specification provides various examples of operations being automatically performed in response to actions the user has taken.
Approximately—refers to a value that is almost correct or exact. For example, approximately can refer to a value that is within 1 to 10 percent of the exact (or desired) value. It should be noted, however, that the actual threshold value (or tolerance) can be application dependent. For example, in some embodiments, “approximately” can mean within 0.1% of some specified or desired value, while in various other embodiments, the threshold can be, for example, 2%, 3%, 5%, and so forth, as desired or as required by the particular application.
Concurrent—refers to parallel execution or performance, where tasks, processes, or programs are performed in an at least partially overlapping manner. For example, concurrency can be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

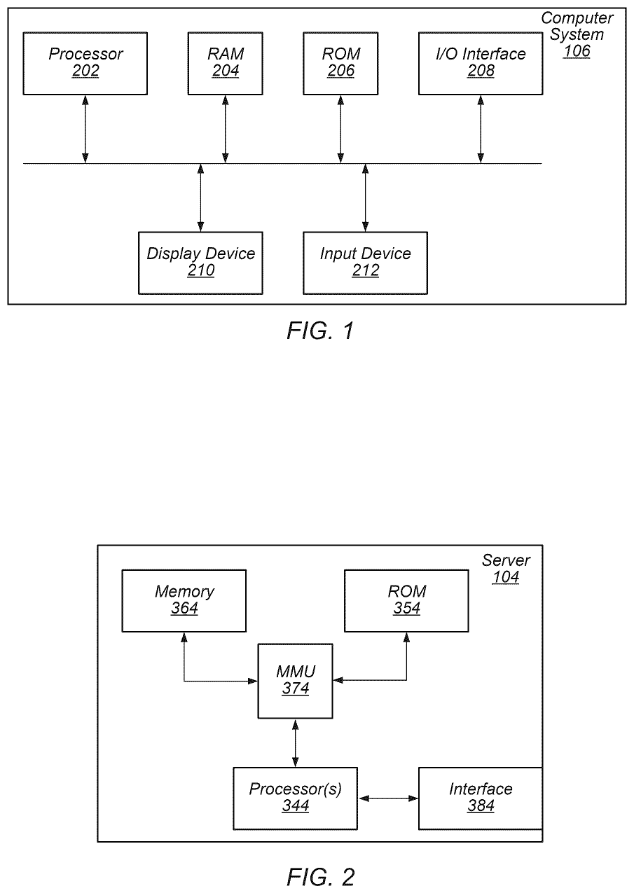

### FIG. 1: Computer System

FIG. 1 illustrates a computer system 106 that can include a processor 202, random access memory (RAM) 204, nonvolatile memory (ROM) 206, a display device 210, an input device 212 and an I/O interface 208 for coupling to sensors. For example, the computer system 106 can include hardware and software components for implementing or supporting implementation of features described herein. The processor 202 can be configured to implement or support implementation of part or all of the methods described herein, e.g., by executing program instructions stored on a memory medium (e.g., a non-transitory computer-readable memory medium). Alternatively, the processor 202 can be configured as a programmable hardware element, such as an FPGA (Field Programmable Gate Array), or as an ASIC (Application Specific Integrated Circuit), or a combination thereof. Alternatively (or in addition) the processor 202, in conjunction with one or more of the other components 204, 206, 208, 210, and/or 212 can be configured to implement or support implementation of part or all of the features described herein.

In addition, as described herein, processor(s) 202 can be comprised of one or more processing elements. In other words, one or more processing elements can be included in processor(s) 202. Thus, processor(s) 202 can include one or more integrated circuits (ICs) that are configured to perform the functions of processor(s) 202. In addition, each integrated circuit can include circuitry (e.g., first circuitry, second circuitry, etc.) configured to perform the functions of processor(s) 202.

As shown, the computer system 106 can include a processor that is coupled to a random access memory (RAM) and a nonvolatile memory. The computer system 106 can also include user interface elements for receiving user input and a display device for presenting output. For example, the user interface elements can include any of various elements, such as a display (which can be a touchscreen display), a keyboard (which can be a discrete keyboard or can be implemented as part of a touchscreen display), a mouse, a microphone and/or speakers, one or more cameras, one or more buttons, and/or any of various other elements capable of providing information to a user and/or receiving or interpreting user input. The computer system 106 can also include an Input/Output (I/O) interface that can be communicatively coupled (e.g., locally via a system bus, or remotely via a network and/or serial interface) to various hardware elements (e.g., such as FPGAs, data acquisition boards, controllers, and the like).

### FIG. 2: Server

FIG. 2 illustrates an example block diagram of a server 104, according to some embodiments. It is noted that the server of FIG. 2 is merely one example of a possible server. As shown, the server 104 can include processor(s) 344 which can execute program instructions for the server 104. The processor(s) 344 can also be coupled to memory management unit (MMU) 374, which can be configured to receive addresses from the processor(s) 344 and translate those addresses to locations in memory (e.g., memory 364 and read only memory (ROM) 354) or to other circuits or devices.

The server 104 can be configured to provide a plurality of devices, such as computer system 106, access to a generative AI, e.g., as further described herein.

In some embodiments, the server 104 can be accessed via a radio access network, such as a 5G New Radio (5G NR) radio access network, e.g., via supported and/or via interface 384. In some embodiments, the server 104 can be accessed via a local area network (LAN), e.g., via an ethernet and/or Wi-Fi connection (e.g., supported and/or via interface 384).

As described further subsequently herein, the server 104 can include hardware and software components for implementing or supporting implementation of features described herein. The processor 344 of the server 104 can be configured to implement or support implementation of part or all of the methods described herein, e.g., by executing program instructions stored on a memory medium (e.g., a non-transitory computer-readable memory medium). Alternatively, the processor 344 can be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 can be configured to implement or support implementation of part or all of the features described herein.

In addition, as described herein, processor(s) 344 can be comprised of one or more processing elements. In other words, one or more processing elements can be included in processor(s) 344. Thus, processor(s) 344 can include one or more integrated circuits (ICs) that are configured to perform the functions of processor(s) 344. In addition, each integrated circuit can include circuitry (e.g., first circuitry, second circuitry, etc.) configured to perform the functions of processor(s) 344.

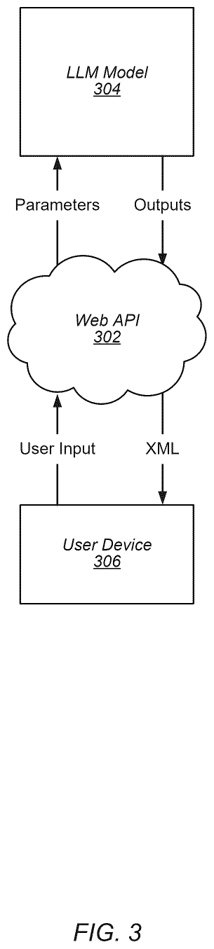

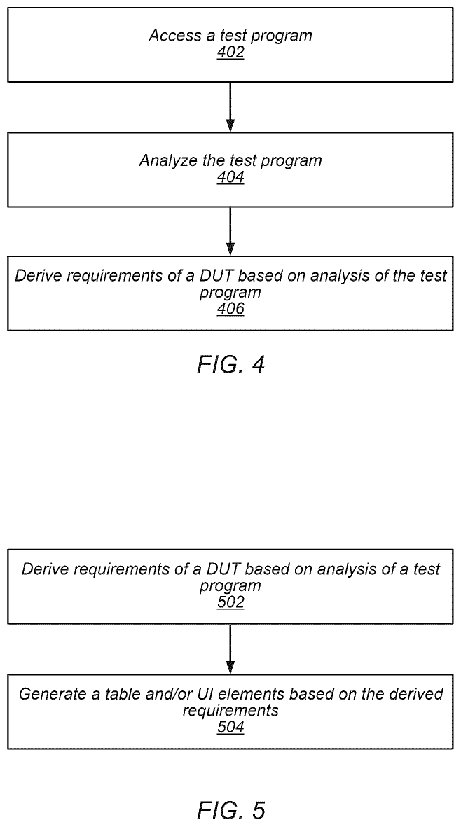

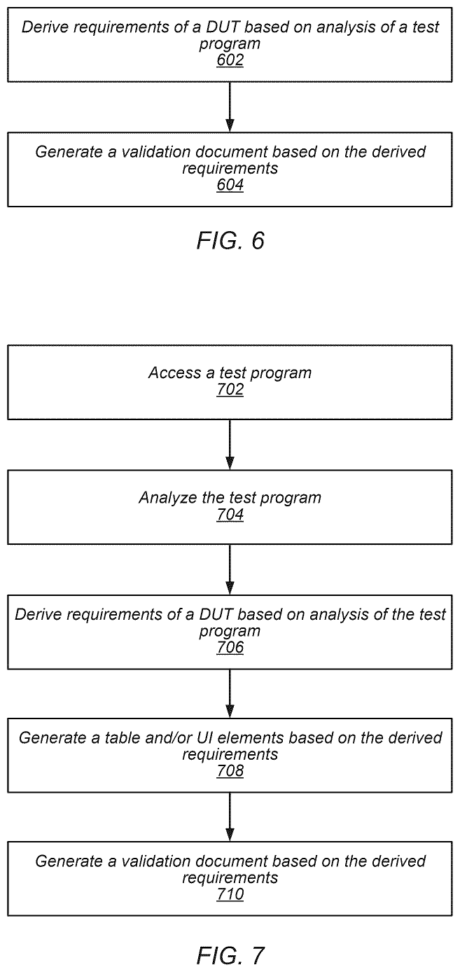

### FIG. 3: Test Requirements Derivation System

FIG. 3 illustrates an example of a system supporting a test requirements derivation system, according to some embodiments. As shown, the system can include a user device 306, e.g., which can be a computer system 106 that provides an interface with a LLM model 304 (e.g., which can be hosted on a server, such as server 104) via a web Application Programming Interface (API) 302. In at least some instances, the LLM model 304 can be one or more models 304 (e.g., one or more artificial intelligence models). The interface can allow the LLM model 304 to interact with (e.g., communicate with) local hardware either on the user device 306 and/or in communication with the user device 306. In addition, the interface can allow the LLM model 304 to interact with local software resources (e.g., such as programming platforms (e.g., LabVIEW™, Python, MeasurementLink, C++, MATLAB™, and so forth). Thus, as shown, a user can interact with the LLM model 304 via web API 302 using the user device 306. The user device 306 can execute one or more software resources as well as host hardware (e.g., such as data acquisition boards, control boards, vision boards, and the like) and/or communicate with remote hardware (e.g., such as data acquisition boards, control boards, vision boards, and the like). The user device 306 can provide user inputs, including information regarding available hardware and/or software resources to the web API 302. The web API 302 can convert the user inputs to LLM model parameters and/or the web API 302 can generate LLM model parameters based on the user inputs. The LLM model parameters can be used by the LLM model 304 to generate and/or produce model outputs that are returned to the web API 302. The web API 302 can then convert the model outputs to Extensible Markup Language (XML) and/or generate XML based on the model outputs. For example, the model outputs can include requirements tables (e.g., that can be viewed, refined, and manipulated) and validation documents associated with a device under test (DUT) that can converted (e.g., serialized) to Large Language Model (LLM) optimized XML, JavaScript Object Notation (JSON), and/or a Domain Specific Language (DSL). The XML can then be delivered to the user device 306 as natural language output to an end user. In this manner, the LLM model 304 can interact with the end user to review and/or revise the requirements tables and/or validation documents. Note that the LLM model 304 can be trained to query end users using a plurality of prompts based on user input. Note further, that aspects of the LLM model 304 can include a user interface executing on the user device 306 as well as background software to discover and maintain hardware information as well as to discover and maintain connections with local applications, the web API 302 to allow the user device 306 to interact with the LLM model 304, and the LLM model 304 that can be executing on a server remote from the user (e.g., the LLM model 304 can be cloud based).

### AI Augmented Requirements Derivation

Currently, in various industries, such as medical technology, aerospace, and test and measurement, compliance can require thorough documentation of requirements, validation protocols, and user procedures. However, users (e.g., such as test engineers and/or compliance engineers) often start with only a test program, e.g., a software routine designed to validate a device under test (DUT), along with scattered supporting materials such as specifications, user manuals, audio/video recordings, and engineering notes. Thus, extracting explicit, implicit, and missing requirements from these assets is a challenging, time-consuming task akin to reverse engineering. Engineers, quality assurance teams, and regulatory specialists must manually interpret the test program's logic, infer requirements, and create structured validation documentation. This process can be slow, error-prone, and resource-intensive. Therefore, improvements are desirable.

Embodiments described herein provide systems, methods, and mechanisms for testing requirements derivation, e.g., using a generative AI based system to derive requirements and tests for a device under test (DUT) from a test program and related materials and generate associated documentation. For example, a large language model (LLM), e.g., AI, can be leveraged to automate requirements extraction, augment derivation of requirements tables (or table), and to collaborate on validation documents generation. In some instances, embodiments described herein can reduce manual effort for a user in requirement extraction and validation, reducing months of effort into hours or days of efforts. In addition, in some instances, embodiments described herein can enable and/or support enhanced compliance reporting resulting in a significant reduction in time for compliance reporting and thereby improving time-to-market for regulated industries. Further, in some instances, embodiments described herein can enhance accuracy and compliance via a reduction in human error in requirements derivation as well as aid in meeting Food and Drug Administration (FDA), International Organization for Standardization (ISO), Institute of Electrical and Electronics Engineers (IEEE), and/or other industry-specific regulatory standards.

In some instances, an AI (e.g., an LLM) can analyze a test program's structure, logic, and/or outputs to infer and/or derive functional requirements and/or non-functional requirements of a DUT. In other words, the AI can consume a test program's structure, logic, and/or outputs to infer and/or derive functional requirements and/or non-functional requirements of a DUT. In addition, the AI can cross-reference test program behavior with uploaded assets (e.g., specifications, logs, video files, and so forth) to increase and/or ensure accuracy of the inferred and/or derived functional requirements and/or non-functional requirements of the DUT. In addition, the AI can flag and/or note gaps and/or ambiguities in requirements (e.g., functional and/or non-functional) for human review. In this manner, requirements (e.g., for compliance purposes) can be derived and/or extracted from the test program's structure, logic, and/or outputs.

In some instances, an AI can (automatically) generate a table, an interlinear report, a margin report and/or one or more other user interface elements. The table can be a structured, editable table. The table and/or the one or more other user interface elements can include derived requirements. The interlinear report and/or margin report can appear in source documentation and show provenance of where the derived requirements came from. The derived requirements can include links to source evidence. A user can then review, refine, and/or manipulate the derived requirements within a user interface (UI), e.g., an intuitive UI. The derived requirements can be categorized into one or more categories. The one or more categories can include, for example, a performance category, a safety category, a compliance category, and so forth. In some instances, a category, e.g., of the one or more categories, can be linked to a specific test program section. In addition, the derived requirements can include an indication of provenance, e.g., an indication of a source document from which a requirement was derived. In this manner, an AI-augmented requirements table for a DUT can be generated.

In some instances, an AI can generate a validation document, e.g., based on the derived requirements. For example, the AI can apply a validation document template and fill in sections of the validation document template using the derived requirements and/or user inputs to generate the validation document. In other words, the AI can populate fields of the validation document template based, at least in part, on the derived requirements and/or user inputs to generate the validation document. The validation document template can be predefined, at least in some instances. Further, the AI can engage a user, e.g., via a UI, in a review process of the validation document. For example, the AI can guide a user through a review process, including prompting a user via the UI regarding AI detected ambiguities and/or incompleteness in the validation document as well as responding to user AI queries regarding user detected ambiguities and/or incompleteness in the validation document. In addition, the AI can suggest missing test cases, compliance considerations, and/or industry-standard formatting. In this manner, a collaborative, AI-powered validation document can be generated.

In some instances, an AI can generate and/or produce additional documentation, e.g., based, at least in part, on derived requirements. For example, the AI can produce and/or generate user manuals, test and/or DUT setup procedures, compliance reports, and/or troubleshooting guides. Such additional documentation can be exported from the AI into a variety of formats. For example, such additional documentation can be exported from the AI in a Word™ format, a portable document format (PDF) format, an XML format, a JSON format, and/or other industry-specific formats for regulatory submission.

For example, FIGS. 4, 5, 6, and 7 illustrate block diagrams of examples of methods for testing requirements derivation for a DUT, according to some embodiments. The methods shown in FIGS. 4, 5, 6, and 7 can be used in conjunction with any of the systems, methods, or devices shown in the Figures, among other devices. In various embodiments, some of the elements shown can be performed concurrently, in a different order than shown, or can be omitted. Additional elements can also be performed as desired. Turning to FIG. 4, as shown, this method can operate as follows.

At 402, a large language model (LLM), such as LLM 304 (e.g., an Artificial Intelligence (AI) and/or AI model) can access a test program, e.g., for testing a DUT. For example, an end user can interact with a user interface on a user device, such as user device 306, to provide instructions to the LLM to access the test program. In addition, the LLM can access any other documentation associated with the DUT provided to the LLM, e.g., user manuals, technical specifications, regulatory requirements, and so forth. The instructions can be provided directly to the LLM from the user device or can be provided to the LLM via an Application Program Interface (API), such as API 302. In other words, the LLM can receive instructions to access the test program. In some instances, the LLM can be located on a server. The server can be a cloud-based server, at least in some instances. In some instances, the user interface can include a chat box for interacting with and/or providing instructions and/or commands to the LLM.

At 404, the LLM can analyze the test program. For example, the LLM can analyze (e.g., review, consume, and/or compare to previously analyzed test programs) a structure of the test program, logic of the test program, and/or outputs of the test program. to infer and/or derive functional requirements and/or non-functional requirements of the DUT. In other words, the AI can consume the structure, the logic, and/or the outputs of the test program and/or compare the structure, the logic, and/or the outputs of the test program to previously analyzed and/or consumed/reviewed test programs. In some instances, the LLM can cross-reference behavior of the test program with uploaded assets (e.g., specifications, logs, video files, and so forth) as part of the analysis. In addition, the LLM can analyze any other documentation associated with the DUT, e.g., user manuals, technical specifications, regulatory requirements, and so forth.

At 406, the LLM can infer and/or derive functional requirements and/or non-functional requirements (e.g., derived requirements) of the DUT, e.g., based on the analysis of the test program and/or any other documentation associated with the DUT. In addition, the LLM can flag and/or note gaps and/or ambiguities in requirements (e.g., functional and/or non-functional) for human review. In this manner, requirements (e.g., for compliance purposes) can be derived and/or extracted from the structure, the logic, and/or the outputs of the test program.

In some instances, the LLM can (automatically) generate a table, an interlinear report, a margin report, and/or one or more other user interface elements, e.g., based on the inferred and/or derived functional requirements and/or non-functional requirements (e.g., derived requirements) of the DUT. The table can be a structured, editable table. The table and/or the one or more other user interface elements can include derived requirements. The derived requirements can include links to source evidence (e.g., specifications, logs, video files, and so forth). A user can then review, refine, and/or manipulate the derived requirements within a user interface (UI), e.g., an intuitive UI. The derived requirements can be categorized into one or more categories. The one or more categories can include, for example, a performance category, a safety category, a compliance category, and so forth. In some instances, a category, e.g., of the one or more categories, can be linked to a specific test program section. In this manner, an AI-augmented requirements table for the DUT can be generated.

In some instances, the LLM can generate a validation document, e.g., based on the derived requirements. For example, the LLM can apply a validation document template and fill in sections of the validation document template using the derived requirements and/or user inputs to generate the validation document. In other words, the LLM can populate fields of the validation document template, e.g., based, at least in part, on the derived requirements and/or user inputs to generate the validation document. The validation document template can be predefined, at least in some instances. Further, the LLM can engage a user, e.g., via the UI, in a review process of the validation document. For example, the LLM can prompt the user via the UI regarding detected ambiguities and/or incompleteness in the validation document as well as respond to user queries regarding user detected ambiguities and/or incompleteness in the validation document. In addition, the LLM can suggest missing test cases, compliance considerations, and/or industry-standard formatting.

In some instances, an LLM can generate and/or produce additional documentation, e.g., based, at least in part, on the derived requirements. For example, the LLM can produce and/or generate user manuals, test procedures, DUT setup procedures, compliance reports, and/or troubleshooting guides. Such additional documentation can be exported from the LLM into a variety of formats. For example, such additional documentation can be exported from the LLM in a Word™ format, a PDF format, an XML format, a JSON format, and/or other industry-specific formats for regulatory submission.

Turning to FIG. 5, as shown, this method can operate as follows.

At 502, a large language model (LLM), such as LLM 304 (e.g., AI and/or AI model), can infer and/or derive functional requirements and/or non-functional requirements (e.g., derived requirements) of a device under test (DUT), e.g., based on an analysis of a test program and/or any other documentation associated with the DUT. For example, an end user can interact with a user interface on a user device, such as user device 306, to provide instructions to the LLM to access the test program. The instructions can be provided directly to the LLM from the user device or can be provided to the LLM via an Application Program Interface (API), such as API 302. In some instances, the LLM can be located on a server. The server can be a cloud-based server, at least in some instances. In some instances, the user interface can include a chat box for interacting with and/or providing instructions and/or commands to the LLM. In addition, the LLM can analyze the test program. For example, the LLM can analyze (e.g., review, consume, and/or compare to previously analyzed test programs) a structure of the test program, logic of the test program, and/or outputs of the test program. In other words, the AI can consume the structure, the logic, and/or the outputs of the test program and/or compare the structure, the logic, and/or the outputs of the test program to previously analyzed and/or consumed/reviewed test programs. In some instances, the LLM can cross-reference behavior of the test program with uploaded assets (e.g., specifications, logs, video files, and so forth) as part of the analysis. Further, the LLM can flag and/or note gaps and/or ambiguities in requirements (e.g., functional and/or non-functional) for human review. In this manner, requirements (e.g., for compliance purposes) can be derived and/or extracted from the structure, the logic, and/or the outputs of the test program. In addition, the LLM can analyze any other documentation associated with the DUT, e.g., user manuals, technical specifications, regulatory requirements, and so forth

At 504, the LLM can (automatically) generate a table, an interlinear report, a margin report, and/or one or more other user interface elements, e.g., based on the inferred and/or derived functional requirements and/or non-functional requirements (e.g., derived requirements) of the DUT. The table can be a structured, editable table. The table and/or the one or more other user interface elements can include derived requirements. The derived requirements can include links to source evidence (e.g., specifications, logs, video files, and so forth). A user can then review, refine, and/or manipulate the derived requirements within a user interface (UI), e.g., an intuitive UI. The derived requirements can be categorized into one or more categories. The one or more categories can include, for example, a performance category, a safety category, a compliance category, and so forth. In some instances, a category, e.g., of the one or more categories, can be linked to a specific test program section. In this manner, an AI-augmented requirements table for the DUT can be generated.

In some instances, the LLM can generate a validation document, e.g., based on the derived requirements. For example, the LLM can apply a validation document template and fill in sections of the validation document template using the derived requirements and/or user inputs to generate the validation document. In other words, the LLM can populate fields of the validation document template, e.g., based, at least in part, on the derived requirements and/or user inputs to generate the validation document. The validation document template can be predefined, at least in some instances. Further, the LLM can engage a user, e.g., via the UI, in a review process of the validation document. For example, the LLM can prompt the user via the UI regarding detected ambiguities and/or incompleteness in the validation document as well as respond to user queries regarding user detected ambiguities and/or incompleteness in the validation document. In addition, the LLM can suggest missing test cases, compliance considerations, and/or industry-standard formatting.

In some instances, an LLM can generate and/or produce additional documentation, e.g., based, at least in part, on the derived requirements. For example, the LLM can produce and/or generate user manuals, test procedures, DUT setup procedures, compliance reports, and/or troubleshooting guides. Such additional documentation can be exported from the LLM into a variety of formats. For example, such additional documentation can be exported from the LLM in a Word™ format, a PDF format, an XML format, a JSON format, and/or other industry-specific formats for regulatory submission.

Turning to FIG. 6, as shown, this method can operate as follows.

At 602, a large language model (LLM), such as LLM 304 (e.g., AI and/or AI model), can infer and/or derive functional requirements and/or non-functional requirements (e.g., derived requirements) of a device under test (DUT), e.g., based on an analysis of a test program and/or any other documentation associated with the DUT. For example, an end user can interact with a user interface on a user device, such as user device 306, to provide instructions to the LLM to access the test program. The instructions can be provided directly to the LLM from the user device or can be provided to the LLM via an Application Program Interface (API), such as API 302. In some instances, the LLM can be located on a server. The server can be a cloud-based server, at least in some instances. In some instances, the user interface can include a chat box for interacting with and/or providing instructions and/or commands to the LLM. In addition, the LLM can analyze the test program. For example, the LLM can analyze (e.g., review, consume, and/or compare to previously analyzed test programs) a structure of the test program, logic of the test program, and/or outputs of the test program. In other words, the AI can consume the structure, the logic, and/or the outputs of the test program and/or compare the structure, the logic, and/or the outputs of the test program to previously analyzed and/or consumed/reviewed test programs. In some instances, the LLM can cross-reference behavior of the test program with uploaded assets (e.g., specifications, logs, video files, and so forth) as part of the analysis. Further, the LLM can flag and/or note gaps and/or ambiguities in requirements (e.g., functional and/or non-functional) for human review. In this manner, requirements (e.g., for compliance purposes) can be derived and/or extracted from the structure, the logic, and/or the outputs of the test program. In addition, the LLM can analyze any other documentation associated with the DUT, e.g., user manuals, technical specifications, regulatory requirements, and so forth

At 604, the LLM can generate a validation document, e.g., based on the derived requirements. For example, the LLM can apply a validation document template and fill in sections of the validation document template using the derived requirements and/or user inputs to generate the validation document. In other words, the LLM can populate fields of the validation document template, e.g., based, at least in part, on the derived requirements and/or user inputs to generate the validation document. The validation document template can be predefined, at least in some instances. Further, the LLM can engage a user, e.g., via the UI, in a review process of the validation document. For example, the LLM can prompt the user via the UI regarding detected ambiguities and/or incompleteness in the validation document as well as respond to user queries regarding user detected ambiguities and/or incompleteness in the validation document. In addition, the LLM can suggest missing test cases, compliance considerations, and/or industry-standard formatting.

In some instances, the LLM can (automatically) generate a table, an interlinear report, a margin report, and/or one or more other user interface elements, e.g., based on the inferred and/or derived functional requirements and/or non-functional requirements (e.g., derived requirements) of the DUT. The table can be a structured, editable table. The table and/or the one or more other user interface elements can include derived requirements. The derived requirements can include links to source evidence (e.g., specifications, logs, video files, and so forth). A user can then review, refine, and/or manipulate the derived requirements within a user interface (UI), e.g., an intuitive UI. The derived requirements can be categorized into one or more categories. The one or more categories can include, for example, a performance category, a safety category, a compliance category, and so forth. In some instances, a category, e.g., of the one or more categories, can be linked to a specific test program section. In this manner, an AI-augmented requirements table for the DUT can be generated.

In some instances, an LLM can generate and/or produce additional documentation, e.g., based, at least in part, on the derived requirements. For example, the LLM can produce and/or generate user manuals, test procedures, DUT setup procedures, compliance reports, and/or troubleshooting guides. Such additional documentation can be exported from the LLM into a variety of formats. For example, such additional documentation can be exported from the LLM in a Word™ format, a PDF format, an XML format, a JSON format, and/or other industry-specific formats for regulatory submission.

Turning to FIG. 7, as shown, this method can operate as follows.

At 702, a large language model (LLM), such as LLM 304 (e.g., an Artificial Intelligence (AI) and/or AI model) can access a test program, e.g., for testing a DUT. For example, an end user can interact with a user interface on a user device, such as user device 306, to provide instructions to the LLM to access the test program. In addition, the LLM can access any other documentation associated with the DUT provided to the LLM, e.g., user manuals, technical specifications, regulatory requirements, and so forth. The instructions can be provided directly to the LLM from the user device or can be provided to the LLM via an Application Program Interface (API), such as API 302. In other words, the LLM can receive instructions to access the test program. In some instances, the LLM can be located on a server. The server can be a cloud-based server, at least in some instances. In some instances, the user interface can include a chat box for interacting with and/or providing instructions and/or commands to the LLM.

At 704, the LLM can analyze the test program. For example, the LLM can analyze (e.g., review, consume, and/or compare to previously analyzed test programs) a structure of the test program, logic of the test program, and/or outputs of the test program. In other words, the AI can consume the structure, the logic, and/or the outputs of the test program and/or compare the structure, the logic, and/or the outputs of the test program to previously analyzed and/or consumed/reviewed test programs. In some instances, the LLM can cross-reference behavior of the test program with uploaded assets (e.g., specifications, logs, video files, and so forth) as part of the analysis. In addition, the LLM can analyze any other documentation associated with the DUT, e.g., user manuals, technical specifications, regulatory requirements, and so forth.

At 706, the LLM can infer and/or derive functional requirements and/or non-functional requirements (e.g., derived requirements) of the DUT, e.g., based on the analysis of the test program and/or the analysis of any other documentation associated with the DUT. In addition, the LLM can flag and/or note gaps and/or ambiguities in requirements (e.g., functional and/or non-functional) for human review. In this manner, requirements (e.g., for compliance purposes) can be derived and/or extracted from the structure, the logic, and/or the outputs of the test program.

At 708, the LLM can (automatically) generate a table, an interlinear report, a margin report, and/or one or more other user interface elements, e.g., based on the inferred and/or derived functional requirements and/or non-functional requirements (e.g., derived requirements) of the DUT. The table can be a structured, editable table. The table and/or the one or more other user interface elements can include derived requirements. The derived requirements can include links to source evidence (e.g., specifications, logs, video files, and so forth). A user can then review, refine, and/or manipulate the derived requirements within a user interface (UI), e.g., an intuitive UI. The derived requirements can be categorized into one or more categories. The one or more categories can include, for example, a performance category, a safety category, a compliance category, and so forth. In some instances, a category, e.g., of the one or more categories, can be linked to a specific test program section. In this manner, an AI-augmented requirements table for the DUT can be generated.

At 710, the LLM can generate a validation document, e.g., based on the derived requirements. For example, the LLM can apply a validation document template and fill in sections of the validation document template using the derived requirements and/or user inputs to generate the validation document. In other words, the LLM can populate fields of the validation document template, e.g., based, at least in part, on the derived requirements and/or user inputs to generate the validation document. The validation document template can be predefined, at least in some instances. Further, the LLM can engage a user, e.g., via the UI, in a review process of the validation document. For example, the LLM can prompt the user via the UI regarding detected ambiguities and/or incompleteness in the validation document as well as respond to user queries regarding user detected ambiguities and/or incompleteness in the validation document. In addition, the LLM can suggest missing test cases, compliance considerations, and/or industry-standard formatting.

In some instances, an LLM can generate and/or produce additional documentation, e.g., based, at least in part, on the derived requirements. For example, the LLM can produce and/or generate user manuals, test procedures, DUT setup procedures, compliance reports, and/or troubleshooting guides. Such additional documentation can be exported from the LLM into a variety of formats. For example, such additional documentation can be exported from the LLM in a Word™ format, a PDF format, an XML format, a JSON format, and/or other industry-specific formats for regulatory submission.

Embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a computer system 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for deriving requirements and validation artifacts for a device under test (DUT), comprising, by an artificial intelligence model:
accessing a test program configured to test the DUT and documentation associated with the DUT;
analyzing the test program and the documentation;
deriving one or more requirements of the DUT based, at least in part, on the analysis of the test program and the documentation associated with the DUT;
generating at least one user interface (UI) element based on the derived one or more requirements; and
generating a validation document for the DUT based on the derived one or more requirements.

2. The method of claim 1,
wherein analyzing the test program and the documentation comprises identifying one or more test conditions, test parameters, or expected results.

3. The method of claim 1,
wherein deriving the one or more requirements comprises mapping one or more portions of the test program or one or more portions of the documentation to corresponding functional or performance requirements of the DUT.

4. The method of claim 1,
wherein the at least one UI element comprises a table presenting the derived one or more requirements.

5. The method of claim 4,
wherein the table associates each derived requirement with a corresponding portion of the test program or a corresponding portion of the documentation.

6. The method of claim 1,
wherein the validation document comprises a compliance, verification, or validation document for the DUT.

7. The method of claim 1, further comprising, by the artificial intelligence model:
presenting the derived one or more requirements to a user for review and modification via the at least one UI element.

8. The method of claim 1, further comprising, by the artificial intelligence model:
automatically updating the derived one or more requirements in response to modifications to the test program or documentation.

9. The method of claim 1,
wherein the artificial intelligence model comprises a large language model (LLM).

10. A non-transitory computer readable memory medium storing program instructions which, when executed by a processor, are configured to cause a computing device to execute an artificial intelligence model to perform operations comprising:
accessing a test program configured to test a device under test (DUT) and documentation associated with the DUT;
analyzing the test program and the documentation;
deriving one or more requirements of the DUT based, at least in part, on the analysis of the test program and the documentation associated with the DUT;
generating at least one user interface (UI) element based on the derived one or more requirements; and
generating a validation document for the DUT based on the derived one or more requirements.

11. The non-transitory computer readable memory medium of claim 10,
wherein deriving the one or more requirements comprises associating a derived requirement with provenance information identifying at least one portion of the test program or at least one portion of the documentation from which the requirement was derived.

12. The non-transitory computer readable memory medium of claim 10,
wherein deriving the one or more requirements comprises categorizing the derived requirements into two or more requirement types.

13. The non-transitory computer readable memory medium of claim 10,
wherein the program instructions are further executable by the artificial intelligence model to perform operations comprising identifying at least one inconsistency or gap between the test program and the documentation based on the analysis.

14. The non-transitory computer readable memory medium of claim 10,
wherein the program instructions are further executable by the artificial intelligence model to perform operations comprising populating a predefined validation document template based on the derived one or more requirements.

15. The non-transitory computer readable memory medium of claim 14,
wherein the validation document includes references linking derived requirements to corresponding portions of the test program or the documentation.

16. A computer system, comprising:
a memory;
at least one display; and
at least one processor in communication with the memory and the at least one display,
wherein the at least one processor is configured to execute an artificial intelligence model to perform operations comprising:
accessing a test program configured to test a device under test (DUT) and documentation associated with the DUT;
analyzing the test program and the documentation;
deriving one or more requirements of the DUT based, at least in part, on the analysis of the test program and the documentation associated with the DUT;
generating at least one user interface (UI) element based on the derived one or more requirements; and
generating a validation document for the DUT based on the derived one or more requirements.

17. The system of claim 16,
wherein, to execute the artificial intelligence model to perform operations comprising generating the validation document, the at least one processor is further configured to execute the artificial intelligence model to perform operations comprising generating the validation document in a machine-readable format.

18. The system of claim 16,
wherein the at least one processor is further configured to execute the artificial intelligence model to perform operations further comprising iteratively refining the derived one or more requirements based on additional analysis of the test program or the documentation.

19. The system of claim 16,
wherein, to execute the artificial intelligence model to perform operations comprising deriving the one or more requirements, the at least one processor is further configured to execute the artificial intelligence model to perform operations comprising deriving a subset of requirements corresponding to a selected portion of the test program or the documentation.

20. The system of claim 16,
wherein the at least one processor is further configured to execute the artificial intelligence model to perform operations further comprising receiving user confirmation of at least one derived requirement prior to generating the validation document.
